(19) United States
(12) Patent Application Publication
(10) Pub. No.: US 2026/0267252 A1
(43) Pub. Date: Sep. 10, 2026

(54) CHARGING-MEMBER CLEANER, IMAGE FORMING APPARATUS, AND PROCESS CARTRIDGE

(71) Applicant: Hiroshi NAKAI, Kanagawa (JP)

(72) Inventor: Hiroshi NAKAI, Kanagawa (JP)

(21) Appl. No.: 19/536,622

(22) Filed: Feb. 11, 2026

(30) Foreign Application Priority Data
Mar. 4, 2025 (JP) 2025-033587

(51) Int. Cl. G03G 15/02

(52) U.S. Cl. CPC G03G 15/0233; G03G 15/02; G03G 15/0225

(57) ABSTRACT

A charging-member cleaner includes a roller member to abut on a charging member of a roller shape to clean the charging member. The roller member includes a foam. The foam has an airflow volume of 90 L/min or more and 200 L/min or less.

### CROSS-REFERENCE TO RELATED APPLICATION

This patent application is based on and claims priority pursuant to 35 U.S.C. § 119(a) to Japanese Patent Application No. 2025-033587, filed on Mar. 4, 2025, in the Japan Patent Office, the entire disclosure of which is hereby incorporated by reference herein.

### TECHNICAL FIELD

The present disclosure relates to a charging-member cleaner, an image forming apparatus, and a process cartridge.

### RELATED ART

In recent years, demand for higher image quality and definition has increased, and, in a developing process, toner with reduced particle size and increased sphericity is increasingly used. By using such a toner, the toner is allowed to adhere to an electrostatic latent image in a dense manner.

However, such a toner having a small particle diameter and sphericity is more likely to pass through a cleaning blade in a cleaning process, and a cleaning failure is more likely to occur. Then, in a case where the toner remaining on an image bearer without being cleaned adheres to a charging roller, the resistance of the surface of the charging roller locally increases, and thus, the charging ability of the charging roller partially decreases in the axial direction, and uniform charging of the image bearer is not performed. Therefore, vertical black streaks tend to appear in the image, particularly under a low temperature and low humidity environment.

In addition, in view of the above problems, many attempts have been made to apply a lubricant such as zinc stearate to the surface of the image bearer to reduce the coefficient of friction of the surface, thereby reducing the frictional force acting between the surface of the image bearer and the member abutting on the surface of the image bearer to improve the cleaning performance. However, even in this case, when there is lubricant powder that has not been sufficiently deposited, the lubricant powder passes through the cleaning blade and adheres to the charging roller, which similarly causes an abnormal image.

Therefore, in order to prevent residual toner and lubricant from adhering to the charging roller, a charging-roller cleaning member for cleaning the surface of the charging roller is required.

As such a charging-roller cleaning member, techniques using various brush members and foams have been proposed.

In order to reduce the contamination of the charging roller by the cleaning member as described above, it is necessary not only to efficiently remove the adhered substance on the surface of the charging roller but also to keep the surface of the cleaning member fresh at all times by taking the removed adhered substance into the cleaning member or separating the removed adhered substance from the cleaning member. Considering the dirt around the unit, it is preferable to take the removed dirty substance into the cleaning member.

However, in a cleaning member, characteristic values for achieving such an action are not clear, the cleaning ability is not maintained due to gradual accumulation of the dirty substances on the surface of the cleaning member over time, and charging-roller contamination is not prevented for a long period of time.

### SUMMARY

The present disclosure described herein provides a charging-member cleaner that includes a roller member to abut on a charging member of a roller shape to clean the charging member. The roller member includes a foam. The foam has an airflow volume of 90 L/min or more and 200 L/min or less.

The present disclosure described herein also provides an image forming apparatus that includes an image bearer; a developing device; the charging member; and the charging-member cleaner. The developing device forms a toner image on a surface of the image bearer. The charging member charges the image bearer. The charging-member cleaner abuts on the charging member to clean the charging member.

The present disclosure described herein also provides a process cartridge detachable from a body of an image forming apparatus. The process cartridge includes an image bearer, the charging member, a developing device, and the charging-member cleaner. The charging member charges the image bearer. The developing device develops, as a toner image, an electrostatic latent image formed on a surface of the image bearer. The charging-member cleaner abuts on the charging member to clean the charging member.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating an image forming apparatus;

FIG. 2 is a schematic diagram illustrating an image forming unit;

FIG. 3 is a schematic diagram illustrating an image forming unit;

FIG. 4 is a schematic diagram illustrating a charging device;

FIG. 5 is a schematic cross-sectional view illustrating a charging roller;

FIG. 6 is a schematic cross-sectional view illustrating a charging-member cleaner;

FIGS. 7A and 7B are schematic diagrams illustrating how a foam takes in a dirty substance;

FIGS. 8A and 8B are schematic diagrams illustrating a mechanism in which the charging-member cleaner takes in dirt;

FIG. 9 is a diagram illustrating a charging-member cleaner; and

FIG. 10 is a diagram illustrating a charging-member cleaner.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

In recent years, a photoconductor unit is required to have a long life, and suppression of charging roller contamination is a major problem. It has been found that, in order to suppress charging roller contamination for a long period of time, it is necessary not only to efficiently remove the adhered substance on the surface of the charging roller but also to store the removed adhered substance in the cleaner to constantly keep the cleaner surface fresh, but characteristic values for achieving this have not been clarified so far.

As described below, according to an aspect of the present disclosure, a charging-member cleaner can maintain the cleaning ability for a charging member and reduce the occurrence of an abnormal image mainly including vertical black streaks for a long period of time.

A charging-member cleaner according to an embodiment of the present disclosure abuts on a charging member of a roller shape to clean the charging member. The charging-member cleaner includes a foam having an airflow volume of 90 L/min or more and 200 L/min or less.

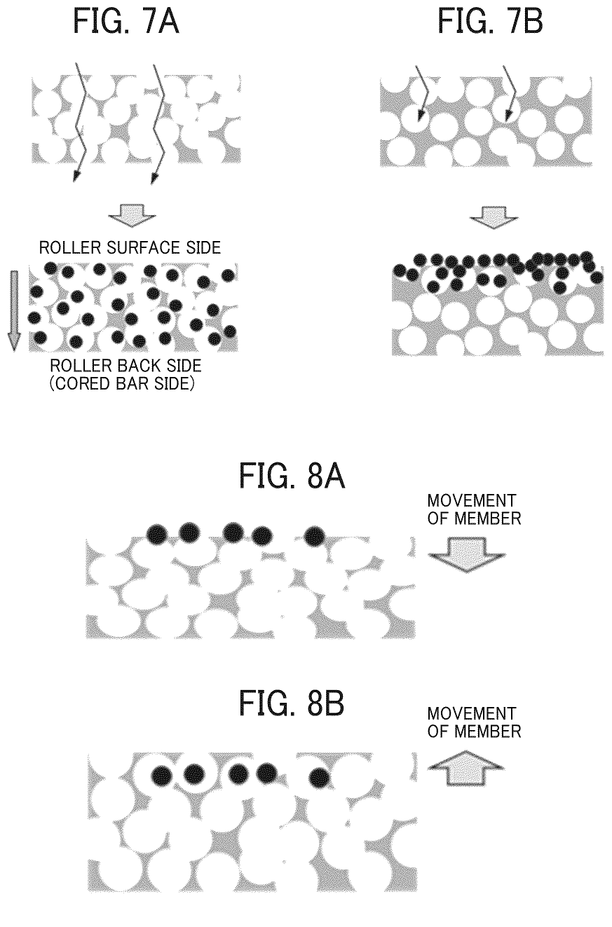

A mechanism for cleaning the charging member by the charging-member cleaner will be described with reference to FIGS. 7A and 7B.

As illustrated in FIG. 7A, when a foam having favorable air permeability is used as the material of the charging-member cleaner, dirt on the surface of the charging member moves from the surface side of the foam to the back side of the foam by a pumping action of the foam, and the surface of the charging member is satisfactorily cleaned. This is attributable to the pumping action of the foam. On the other hand, when a foam having poor air permeability is used as the material of the charging-member cleaner as illustrated in FIG. 7B, the surface of the charging member is not satisfactorily cleaned because dirt on the surface of the charging member stays on the surface of the foam.

When the surface of the charging roller is cleaned while the foam rotates, the foam repeats minute expansion and contraction to exert an action of taking in dirt, that is, the so-called pumping action.

The pumping action of the foam will be described with reference to FIGS. 8A and 8B.

As illustrated in FIG. 8A, when the foam abuts on the charging member of the roller shape, dirt adheres to the surface of the foam while the foam is contracted by a nip pressure. Next, when a portion to which the dirt adheres passes through a nip, the foam expands to take in the dirt as illustrated in FIG. 8B.

The present inventors have found that a value of air permeability is effective as an index indicating the ease of taking in the dirt, and that as the value is larger, charging-roller contamination can be suppressed over a long period of time. Since the air permeability represents the ease of air flow as the name indicates, it is presumed that powder such as toner and lubricant which are dirty substances are also likely to flow in the same manner, and the air permeability is excellent in the action of sending these substances to the inside of the foam.

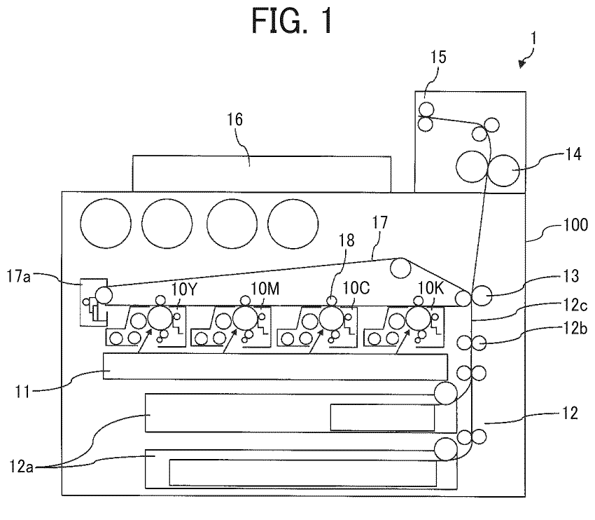

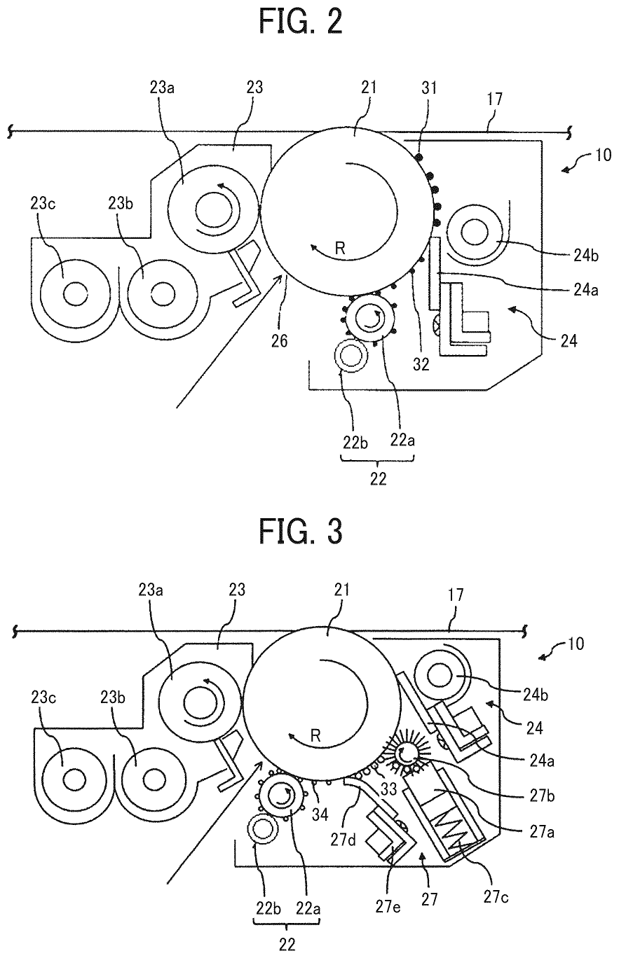

Next, an image forming apparatus will be described with reference to FIGS. 1 and 2.

FIG. 1 is a diagram illustrating an example of a schematic configuration of the image forming apparatus.

In FIG. 1, an image forming apparatus 1 is a four-row tandem image forming apparatus. An image forming unit 10 (10K, 10Y, 10M, 10C) of each color is mounted on the image forming apparatus 1. An example of the image forming unit is illustrated in FIG. 2. As illustrated in FIG. 2, in the image forming unit 10, laser light modulated based on image data to be formed is written from an optical writing device 11 illustrated in FIG. 1 onto a photoconductor 21 whose surface is charged to a predetermined potential by a charging device 22, and a latent image is formed on the photoconductor 21. The latent image is developed by a developing device 23 with the rotation of the photoconductor 21, and a toner image is formed. This toner image is primarily transferred to an intermediate transfer belt 17 by a primary transfer device 18 illustrated in FIG. 1. This primary transfer is also executed by image forming units 10Y, 10M, and 10C of colors other than black, and a full-color image on which four-color toner images are superimposed is finally formed on the intermediate transfer belt 17.

A secondary transfer device 13 collectively transfers the toner image formed on the intermediate transfer belt 17 onto a sheet fed from any one of sheet feeding trays 12a in a sheet feeder 12. At this time, the sheet is sent onto a vertical conveyance path 12c by a registration roller 12b in synchronization with the image on the intermediate transfer belt 17. A fixing device 14 applies heat and pressure to the full-color toner image transferred onto the sheet to fix the full-color toner image onto the sheet, and an ejection device 15 ejects the sheet to an ejection tray 16.

In the photoconductor 21 to which the toner image has been primarily transferred, residual toner on the surface of the photoconductor 21 is cleaned by a photoconductor cleaning device 24 illustrated in FIG. 2, and the surface of the photoconductor 21 is neutralized by a neutralizing device. The photoconductor cleaning device 24 includes a cleaning blade 24a and a waste toner conveyance member 24b, scrapes the residual toner with the cleaning blade 24a, and conveys and collects the scraped residual toner with the waste toner conveyance member 24b. As illustrated in FIG. 1, the intermediate transfer belt 17 is stretched between a driving roller and a driven roller, and a cleaning device 17a of the intermediate transfer belt 17 is disposed on the driving roller side.

FIG. 2 is a diagram illustrating an example of the configuration of an image forming unit 10. The image forming unit 10 includes the drum-shaped photoconductor 21, the charging device 22 disposed along the outer periphery of the photoconductor 21, the developing device 23, the photoconductor cleaning device 24, and the neutralizing device. An optical writing unit 26 irradiated with laser light for optical writing from the optical writing device 11 is set between the charging device 22 and the developing device 23. The neutralizing device is disposed between the photoconductor cleaning device 24 and the charging device 22. The charging device 22 includes a charging roller 22a as a charging member arranged with a gap in the photoconductor 21, and a cleaning roller 22b as a charging-member cleaner that removes dirt from the charging roller 22a. The developing device 23 includes a developing roller 23a and stirring rollers 23b and 23c.

The configuration of the image forming unit illustrated in FIG. 2 is also an example of the configuration of a process cartridge. The process cartridge of the present embodiment is detachable from a body 100 of the image forming apparatus 1, and includes the photoconductor 21 as an image bearer, the charging roller 22a as the charging member that charges the photoconductor 21, the developing device 23 that develops an electrostatic latent image formed on the surface of the photoconductor 21 as a toner image with a developer containing toner, and the cleaning roller 22b as the charging-member cleaner. Further, the process cartridge may include the photoconductor cleaning device 24.

FIG. 3 is a diagram illustrating another example of the configuration of an image forming unit. In the image forming unit, a lubricant applicator 27 is provided in order to improve cleaning performance and transferability of the photoconductor 21.

The lubricant applicator 27 is disposed on the downstream side of the photoconductor cleaning device 24 in a rotation direction R of the photoconductor 21 to stably apply the lubricant. The lubricant application is stabilized because the lubricant applicator is disposed on the downstream side of the photoconductor cleaning device, so that the lubricant can be applied to the surface of the photoconductor after the transfer residual toner is removed. The lubricant is not particularly limited. For example, zinc stearate may be used as the lubricant.

The lubricant applicator 27, for example, rotates a lubricant application brush 27b to supply a lubricant 27a to the surface of the photoconductor 21. In FIG. 3, lubricant 33 represents the lubricant on the photoconductor 21 supplied by the lubricant applicator 27. The lubricant 33 supplied to the photoconductor 21 is adjusted in thickness, application area, etc. by a leveling blade 27d. The leveling blade 27d is held by a holder 27e. The lubricant having passed through the leveling blade 27d is denoted by a reference sign 34 in the drawing. The lubricant applicator 27 may include a spring 27c. The spring 27c applies a biasing force to the lubricant 27a to urge the lubricant 27a toward the lubricant application brush 27b.

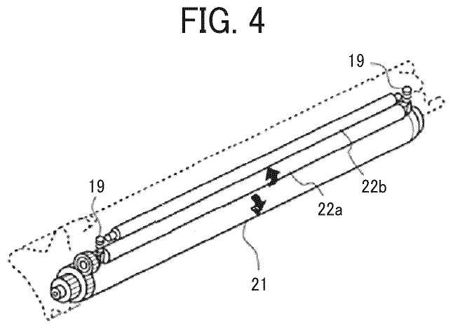

FIG. 4 is a perspective view illustrating an outline of the charging device 22. The charging device 22 includes the charging roller 22a as the charging member arranged to face the photoconductor 21, and the charging-member cleaner 22b arranged to contact the surface of the charging roller 22a which is opposite the surface facing the photoconductor 21. In addition, the charging roller 22a includes a pressure spring 19 which is a biasing member that biases both ends of the charging roller 22a toward the photoconductor 21.

Although a known material can be used for the charging roller 22a, a hard resin as described below is preferably used as the material of the charging roller 22a. Since the hard resin originally has a smooth surface, foreign matter is less likely to adhere to the surface of the charging roller, and a configuration described in the present disclosure is suitable for efficiently removing the adhered foreign matter, and a significant effect can be obtained.

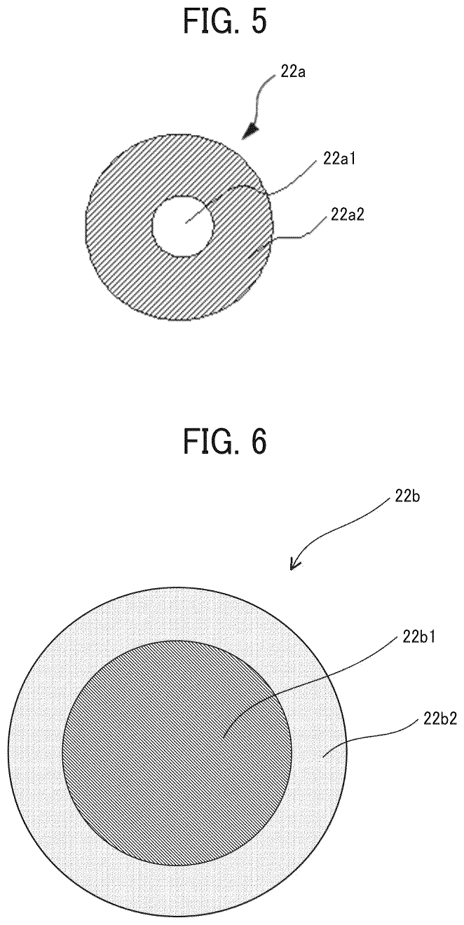

FIG. 5 is an example illustrating a cross-sectional view of the charging roller 22a. The charging roller 22a includes a cored bar 22al as a conductive support having a columnar shape, and a resistance adjustment layer 22a2 formed on the outer peripheral surface of the cored bar 22al with a uniform thickness.

The resistance adjustment layer 22a2 is formed by providing a resin composition on the peripheral surface of the cored bar 22al by extrusion molding, injection molding, or the like. In addition, in order to prevent the resistance adjustment layer 22a2 from being deformed over time and the gap between the photoconductor 21 and the charging roller 22a from changing, the JIS-D hardness of the resistance adjustment layer 22a2 is set to 45 degrees or more.

The thermoplastic resin used for the resistance adjustment layer 22a2 is not particularly limited as long as it can maintain JIS-D hardness after molding, but it is preferable to use a general-purpose resin such as polyurethane, polyethylene (PE), polypropylene (PP), polymethyl methacrylate (PMMA), polystyrene (PS), or a copolymer thereof (acrylonitrile styrene (AS), acrylonitrile butadiene styrene (ABS), etc.) because molding processing is easier.

The resistance adjustment layer 22a2 is formed of a thermoplastic resin composition in which a polymeric ionic conductive agent is dispersed. The volume specific resistance value of the resistance adjustment layer 22a2 is preferably 10⁶ Ω·cm to 109 Ω·cm. This is because when the volume specific resistance value exceeds 109 Ω·cm, the charge amount is insufficient, and a sufficient charge potential is not obtained for the photoconductor 21 to obtain an image without unevenness, whereas when the volume specific resistance value is smaller than 10⁶ Ω·cm, leakage to the entire photoconductor 21 occurs.

As the polymeric ionic conductive agent to be dispersed in the thermoplastic resin, a polymer type ion conductive agent having a single resistance value of about 10⁶ Ω·cm to 10¹⁰ Ω·cm and capable of easily lowering the resistance of the resin is used.

An example thereof is a compound containing a polyether ester amide component. In order to set the resistance value of the resistance adjustment layer 22a2 to a desired value as described above, the blend amount is preferably 30 parts by weight to 70 parts by weight per 100 parts by weight of the base material.

As the polymeric ionic conductive agent, a quaternary ammonium base-containing polymer compound can also be used. Examples thereof include quaternary ammonium base-containing polyolefins. In order to set the resistance value of the resistance adjustment layer 22a2 to a desired value as described above, the blend amount is preferably 10 parts by weight to 40 parts by weight per 100 parts by weight of the base material.

The dispersion of the polymeric ionic conductive agent in the thermoplastic resin can be easily performed by using a device such as a biaxial kneader or a kneader. Since the ion conductive material is uniformly dispersed at a molecular level in the matrix polymer, the resistance value of the resistance adjustment layer 22a2 does not vary due to the dispersion failure of the conductive substance as seen in the resistance adjustment layer in which a conductive pigment is dispersed. The ion conductive material is a polymer compound, and thus is uniformly dispersed and fixed in the matrix polymer, and bleed-out is less likely to occur.

The charging roller 22a is connected to a power supply, and a predetermined voltage is applied thereto. The predetermined voltage may be a direct current (DC) voltage alone. However, the predetermined voltage is preferably obtained by superimposing an alternating current (AC) voltage on the DC voltage. By applying the AC voltage, the surface of the photoconductor 21 can be charged more uniformly.

Further, the charging roller 22a may be disposed in contact with the photoconductor 21, but in an embodiment of the present disclosure, the charging roller is preferably disposed with a minute gap with respect to the photoconductor 21. Although omitted, this minute gap can be set by winding a spacer member having a constant thickness around non-image forming regions at both ends of the charging roller 22a to abut the surface of the spacer member on the surface of the photoconductor 21.

Next, the charging-member cleaner will be described in detail.

FIG. 6 is an example illustrating a cross-sectional view of the charging-member cleaner 22b. The charging-member cleaner 22b includes at least a core member 22b1 and a foam layer 22b2, and may further include other portions as necessary.

The material of the core member 22b1 is not particularly limited, and may be appropriately selected depending on a purpose. Examples of the material of the core member 22b1 include resins and metals. Examples of the resin include epoxy resins and phenol resins. Examples of the metal include iron, aluminum, and stainless steel.

The foam layer 22b2 is formed on the outer periphery of the core member 22bl. The material is not particularly limited, and can be appropriately selected according to the purpose, but foamed polyurethane is particularly preferably used from the viewpoint of excellent durability, easy adjustment of physical properties, and the like.

The airflow volume of the foam layer 22b2 used as the cleaning roller 22b is 90 L/min or more and 200 L/min or less. In the present disclosure, the “airflow volume” is defined to refer to a measured value obtained by a measurement method in accordance with ASTM D3574 Test G. Specifically, it refers to the volume of air passing through a foam portion which is 1.0 inch (2.54 cm) thick and 2 inches×2 inches (5.08 cm) square in 1 minute at a pressure of 125 Pa. Examples of the device for measuring the airflow volume include FX3300 manufactured by TEXTEST.

When the cleaning roller 22b removes the dirty substance from the surface of the charging roller, the dirty substance adheres to the surface of the cleaning member.

As illustrated in FIGS. 7A and 7B, it has become clear from the study of the present inventors that the air permeability of the foam layer is correlated with the ability to take in the dirty substance, and when the air permeability is within a certain range, the dirty substance is more likely to move from the surface of the charging roller toward the inside of the charging-member cleaner 22b. A preferable range of the airflow volume is 90 L/min or more and 200 L/min or less, more preferably 120 L/min or more and 180 L/min or less, and still more preferably 120 L/min or more and 150 L/min or less. When the airflow volume is less than 90, the ability to take in dirt is insufficient, and the cleaning function deteriorates over time. On the other hand, when the airflow volume exceeds 200 L/min, the dirty substance once carried to the back is more likely to flow back and more likely to precipitate on the surface again, and as a result, the cleaning function deteriorates over time.

An average thickness of the foam layer is not particularly limited, and can be appropriately selected according to the purpose, but is preferably 1 mm or more and 4 mm or less. When the average thickness is less than 1 mm, it is easy to pick up the influence of the shaft (core member), and when the average thickness exceeds 4 mm, the component becomes large in size, and the degree of freedom in layout becomes low, which is not preferable. Here, the average thickness is an average value when the thickness of the foam layer is arbitrarily measured at three points.

Examples of the structure of the foam layer include an open-cell type. The open-cell type is preferable in that the open-cell type is hardly deformed even in long-term use because the open-cell type has a small compressive residual strain and easily returns to the original shape even when compressed.

The foam layer also has a stretching action. As illustrated in FIGS. 8A and 8B, a mechanism in which the cleaning roller 22b takes in dirt is considered to be due to the so-called pumping action. According to the study of the present inventors, the dirty substance adhering to the surface of the cleaning member is sent to the inside along with the expansion and contraction of the cleaning member itself, and repulsion elasticity can be used as a characteristic value representing the elasticity. The repulsion elasticity is preferably in the range of 20% or more and 45% or less. Within this range, the cleaning member is particularly excellent in the action of taking in the dirty substance. When the repulsion elasticity of the foam is less than 20%, the foam is less likely to stretch, and when the repulsion elasticity exceeds 45%, the foam is less likely to shrink, and the pumping action is not sufficient in either case.

In the present disclosure, the value of “repulsion elasticity” is defined to refer to a value obtained by a measurement method in accordance with JIS K6400-3.

Furthermore, the percentage of elongation of the foam is preferably 100% or more.

As described above, the pumping action is generated by the expansion and contraction of the cleaning member. When the percentage of elongation is 100% or more, the foam is excellent in durability even when the foam expands and contracts repeatedly, and favorable cleaning performance can be obtained over a longer period of time. In the present disclosure, the value of “repulsion elasticity” is defined to refer to a value obtained by a measurement method in accordance with JIS K6400-5.

The other physical property values of the foam are not particularly specified, but in order to satisfy the physical property values specified above, the hardness is generally in a range of 100 N to 400 N and the number of cells is in a range of 40 cells/inch to 70 cells/inch in many cases. Each physical property value in the foam layer can be controlled by appropriately adjusting the kind of the raw material of the foamed polyurethane, the amount of foaming agent, the reaction conditions, and the like when the foamed polyurethane is produced.

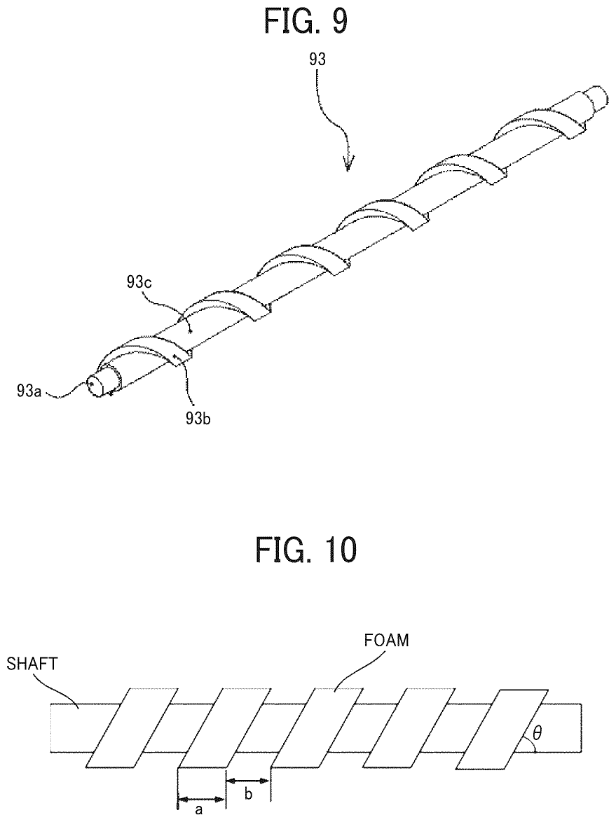

A charging-member cleaner according to another embodiment of the present disclosure is illustrated in FIG. 9. The charging-member cleaner 93 in FIG. 9 may include a shaft portion 93a made of metal, a cleaning portion 93b which is covered on the shaft portion 93a, made of a foam described in the present disclosure, and comes into contact with the charging roller to clean the roller portion, and a non-cleaning portion 93c that is smaller in diameter than the cleaning portion 93b and is not in contact with the charging roller. Specifically, the cleaning portion 93b is formed into a spiral shape in the axial direction, and the non-cleaning portion 93c is formed as a spiral groove between the cleaning portions 93b. Then, the charging-member cleaner 93 alternately appears with the proportion occupied by the cleaning portion 93b and the non-cleaning portion 93c unchanged at the portion facing the charging roller by rotation. The charging-member cleaner 93 configured as described above is preferable because a force for scraping dirt is applied in the longitudinal direction of the shaft along with the rotational movement, and dirt can be removed more efficiently. Here, since the proportion of the cleaning portion 93b and the non-cleaning portion 93c in the portion facing the charging roller does not change even by the rotation of the charging-member cleaner 93, the force received by the contact with the charging roller is constant in the circumferential direction and is substantially uniform also in the axial direction.

### EXAMPLES

Hereinafter, the present disclosure will be described in more detail with reference to Examples.

### Preparation of Charging Device

A charging device was taken out from a photoconductor unit of a copier RICOH IM C5000 manufactured by Ricoh Co., Ltd. having a device configuration substantially equivalent to that of the image forming unit illustrated in FIG. 3, and a charging-member cleaning roller made of a foam having a material, an airflow volume, a repulsion elasticity, and a percentage of elongation illustrated in members 1 to 17 of the following Table 1 was attached to each charging device as the charging-member cleaner. The dimension of the charging-member cleaning roller was each the same as that of the standard product used in RICOH IM C5000.

TABLE 1

| Charging-member | | Airflow | Repulsion | Percentage of |
|---|---|---|---|---|
| cleaning roller | | volume | elasticity | elongation |
| Member No. | Material | (L/min) | (%) | (%) |
| Member 1 | Polyurethane | 120 | 30 | 140 |
| Member 2 | Polyurethane | 150 | 30 | 140 |
| Member 3 | Polyurethane | 95 | 30 | 140 |
| Member 4 | Polyurethane | 190 | 30 | 140 |
| Member 5 | Polyurethane | 120 | 22 | 140 |
| Member 6 | Polyurethane | 120 | 42 | 140 |
| Member 7 | Polyurethane | 120 | 15 | 140 |
| Member 8 | Polyurethane | 120 | 50 | 140 |
| Member 9 | Polyurethane | 120 | 30 | 90 |
| Member 10 | Polyolefin | 120 | 30 | 110 |
| Member 11 | Polyurethane | 75 | 30 | 140 |
| Member 12 | Polyurethane | 40 | 30 | 140 |
| Member 13 | Polyurethane | 220 | 30 | 140 |
| Member 14 | Polyurethane | 300 | 30 | 140 |

### Example 1

A charging device using the member 1 of Table 1 as the charging-member cleaning roller was mounted on a photoconductor unit of a black station of RICOH IM C5000, and actual machine running was performed as follows (a black station was used alone in each case).

Since the larger the lubricant consumption amount in the photoconductor unit, the more disadvantageous the charging-roller contamination, a black vertical-band chart was continuously fed in A4 landscape up to 150,000 sheets under a low temperature and low humidity (10° C., 15%) environment under the condition that the spring pressure of the lubricant application mechanism included in the photoconductor unit of the RICOH IM C5000 was doubled and the consumption amount of the lubricant was increased.

At this time, a blank sheet was passed every 50,000 sheets, and it was confirmed whether vertical black streaks caused by the charging-roller contamination were generated on the image. Specifically, it was confirmed that when a vertical black streak occurred on the image, the photoconductor unit was taken out, and a streak-like stain occurred on the charging roller in a portion corresponding to the vertical black streak on the image. In addition, the degree of the vertical black streak was ranked in five levels, and level 3 or higher of the vertical black streak was regarded as an acceptable level in practical use, and level 2 or lower was regarded as an unacceptable level.

### Evaluation Criteria

5: No streak can be confirmed on the image or on the charging roller. 4: No streak can be confirmed on the image, but five or less streaks can be confirmed on the charging roller. 3: No streak can be confirmed on the image, but six or more streaks can be confirmed on the charging roller. 2: Gray light streaks can be confirmed on the image. 1: Black dark streaks can be confirmed on the image.

### Examples 2 to 10

Evaluation was performed in a manner similar to Example 1 except that a charging device in which the charging-member cleaning roller was changed to the members 2 to 10 in Table 1 was used.

### Example 11

Evaluation was performed in the same manner as in Example 5 except that a charging device was used in which the charging-member cleaning roller was replaced with one made by spirally winding a strip-shaped member 5 around a shaft. At this time, as illustrated in FIG. 10, the charging-member cleaning roller was prepared in a manner that a width a of the cleaning portion was 10 mm, a width b of the non-cleaning portion was 10 mm, and a winding angle θ of the foam with respect to the axis was 45°. The thickness of the member 5 was the same as that in Example 5.

### Comparative Examples 1 to 4

Evaluation was performed in a manner similar to Example 1 except that a charging device in which the charging-member cleaning roller was changed to the members 11 to 14 in Table 1 was used.

The evaluation results are collectively illustrated in Table 2.

TABLE 2

| | | Vertical black streaks on image | | |
|---|---|---|---|---|
| | | After | After | After |
| | Charging roller | 50,000 | 100,000 | 150,000 |
| | cleaner material | sheets | sheets | sheets |
| Example 1 | Member 1 | 5 | 5 | 5 |
| Example 2 | Member 2 | 5 | 5 | 5 |
| Example 3 | Member 3 | 5 | 5 | 4 |
| Example 4 | Member 4 | 5 | 5 | 4 |
| Example 5 | Member 5 | 5 | 5 | 4 |
| Example 6 | Member 6 | 5 | 5 | 4 |
| Example 7 | Member 7 | 4 | 4 | 4 |
| Example 8 | Member 8 | 4 | 4 | 4 |
| Example 9 | Member 9 | 5 | 5 | 3 |
| Example 10 | Member 10 | 5 | 4 | 3 |
| Example 11 | Member 5 | 5 | 5 | 5 |
| | (spiral shape) | | | |
| Comparative | Member 11 | 4 | 3 | 2 |
| Example 1 | | | | |
| Comparative | Member 12 | 4 | 2 | 1 |
| Example 2 | | | | |
| Comparative | Member 13 | 5 | 4 | 2 |
| Example 3 | | | | |
| Comparative | Member 14 | 5 | 3 | 1 |
| Example 4 | | | | |

Based on the comparison between Examples 1 to 11 and Comparative Examples 1 to 4, it is known that in the examples of the present disclosure, a vertical black streak image caused by charging-roller contamination can be suppressed over a long period of time.

Based on the comparison between Examples 1, 5, and 6 and Examples 7 and 8, it is known that a greater effect is obtained when the repulsion elasticity of the foam material is 20% or more and 45% or less.

Based on the comparison between Example 1 and Example 9, it is known that when the percentage of elongation of the foam material is 100% or more, the effect of suppressing charging-roller contamination over time is particularly enhanced.

Based on the comparison between Example 1 and Example 10, it is known that when the foam material is polyurethane, the effect can be more easily obtained, and it is advantageous in terms of material for removing dirty substances on the charging roller.

Based on the comparison between Example 5 and Example 11, it is known that charging-roller contamination can be more efficiently removed and the effect is sustained by using a charging-member cleaning roller obtained by spirally winding the foam around the shaft as the charging roller cleaner.

Aspects of the present disclosure are, for example, as follows.

### Aspect 1

According to Aspect 1, a charging-member cleaner abuts on a charging member which is roller-shaped to clean the charging member, the charging-member cleaner being a roller member including a foam, and an airflow volume of the foam being 90 L/min or more and 200 L/min or less.

Since the action of sending the dirty substances adhering to the surface of the roller member from the surface of the roller member to the inside of the roller member is favorable, the surface of the roller member can be maintained in a fresh state.

### Aspect 2

According to Aspect 2, in the charging-member cleaner of Aspect 1, the airflow volume of the foam is 120 L/min or more and 150 L/min or less.

The action of sending the dirty substances adhering to the surface of the roller member from the surface of the roller member to the inside of the roller member is further improved.

### Aspect 3

According to Aspect 3, in the charging-member cleaner of Aspect 1 or Aspect 2, the foam has elasticity.

Since the foam has elasticity, the pumping action is favorable, and dirt on the surface of the roller member can be more efficiently sent to the inside of the roller member.

### Aspect 4

According to Aspect 4, in the charging-member cleaner of any one of Aspects 1 to 3, repulsion elasticity of the foam is 20% or more and 45% or less.

Since the repulsion elasticity of the foam is 20% or more and 45% or less, the range is excellent in pumping action, and particularly excellent in the action of sending dirt on the surface of the roller member to the inside of the roller member.

### Aspect 5

According to Aspect 5, in the charging-member cleaner of any one of Aspects 1 to 4, a percentage of elongation of the foam is 100% or more.

Since the percentage of elongation of the foam is 100% or more, the foam is less likely to be torn even when expansion and contraction are repeated by pumping action, and durability is excellent.

### Aspect 6

According to Aspect 6, in the charging-member cleaner of any one of Aspects 1 to 5, the foam is foamed polyurethane.

Polyurethane is easy to process as a material and allows the physical property values to be readily controlled.

### Aspect 7

According to Aspect 7, in the charging-member cleaner of any one of Aspects 1 to 6, the foam is formed in a spiral shape on a shaft in the roller member.

By spirally winding the foam on the shaft, a force for scraping off dirt is applied in the longitudinal direction of the shaft, and dirt can be removed more efficiently.

### Aspect 8

According to Aspect 8, an image forming apparatus includes at least: a developing device that forms a toner image on a surface of an image bearer; the charging member that charges the image bearer; and a cleaning unit that abuts on the charging member to clean the charging member, wherein the charging-member cleaner of any one of Aspects 1 to 6 is used as the cleaning unit.

It is possible to provide an image forming apparatus with less abnormal images over a long period of time.

### Aspect 9

According to Aspect 9, a process cartridge is detachable from a body of an image forming apparatus, the process cartridge including: an image bearer; the charging member that charges the image bearer; a developing device that develops an electrostatic latent image formed on a surface of the image bearer as a toner image; and the charging-member cleaner of any one of Aspects 1 to 6.

It is possible to provide a process cartridge with less abnormal images over a long period of time.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A charging-member cleaner, comprising:
a roller member to abut on a charging member of a roller shape to clean the charging member,
the roller member including a foam, the foam having an airflow volume of 90 L/min or more and 200 L/min or less.

2. The charging-member cleaner according to claim 1,
wherein the foam has an airflow volume of 120 L/min or more and 150 L/min or less.

3. The charging-member cleaner according to claim 1,
wherein the foam has elasticity.

4. The charging-member cleaner according to claim 1,
wherein the foam has a repulsion elasticity of 20% or more and 45% or less.

5. The charging-member cleaner according to claim 1,
wherein the foam has a percentage of elongation of 100% or more.

6. The charging-member cleaner according to claim 1,
wherein the foam comprises foamed polyurethane.

7. The charging-member cleaner according to claim 1,
wherein the roller member includes a shaft and the foam formed in a spiral shape on the shaft.

8. An image forming apparatus, comprising:
an image bearer;
a developing device to form a toner image on a surface of the image bearer;
the charging member to charge the image bearer; and
the charging-member cleaner according to claim 1 to abut on the charging member to clean the charging member.

9. A process cartridge detachable from a body of an image forming apparatus, the process cartridge comprising:
an image bearer;
the charging member to charge the image bearer;
a developing device to develop, as a toner image, an electrostatic latent image formed on a surface of the image bearer; and
the charging-member cleaner according to claim 1 to abut on the charging member to clean the charging member.
